(19) United States
(12) Patent Application Publication
(10) Pub. No.: US 2014/0040296 A1
(43) Pub. Date: Feb. 6, 2014

(54) METHOD AND APPARATUS FOR SOFTWARE TESTING

(71) Applicant: Bogdan Ciprian Pistol, Berlin (DE)

(72) Inventor: Bogdan Ciprian Pistol, Berlin (DE)

(73) Assignee: NOKIA CORPORATION, Espoo (FI)

(21) Appl. No.: 13/562,796

(22) Filed: Jul. 31, 2012

(51) Int. Cl. G06F 17/30

(52) U.S. Cl. 707/758; 707/E17.009

(57) ABSTRACT

A method, apparatus and computer program product are provided for testing software programs which use regular expressions. In one regard, a method for determining whether two or more regular expressions are disjoint is provided that includes receiving two or more regular expressions, determining whether at least one common regular expression exists between the two or more regular expressions, and in an instance in which one does not exist, causing an indication of disjointedness to be provided. A corresponding method for determining a common regular expression of two or more regular expressions is also provided that includes causing respective deterministic finite automaton (DFA) representations to be created for two or more regular expressions, causing a DFA representation of a candidate common regular expression to be created based on the DFA representations of the regular expressions and determining if the DFA representation of the candidate common regular expression includes a terminal state.

### TECHNOLOGICAL FIELD

An example embodiment of the present invention relates generally to techniques for testing software and, more particularly, to a method and apparatus for testing whether two or more regular expressions are disjoint.

### BACKGROUND

In general, software testing is merely a best effort proposition as no software testing method can ensure that a given software program is completely error free. This is the case because in most cases, it may not be possible to test every possible program input, as the number of possibilities may be prohibitively large or even unbounded, i.e., infinite.

The inherent limitations of software testing may be compounded in software programs which rely on regular expressions for matching strings. Testing regular expressions may be particularly difficult using conventional testing methods, because conventional tests may only test specific cases, while the number of strings that could match a regular expression is unbounded. This usage may become increasingly error prone as the regular expression patterns become more and more complex. This difficulty may be escalated even further when a given software program uses two or more regular expressions that need to be disjoint, meaning that there is no string that can be matched by all of the two or more regular expressions. Such a requirement for disjointedness may arise, for example, if a program uses two different regular expressions in a conditional statement.

Another problem that may arise in the context of regular expressions is the need to determine whether two or more regular expressions have a common shared regular expression. Note that this issue is not simply the reverse of the abovementioned issue. Because regular expressions represent sets of strings, there are situations when N regular expressions may not be disjoint (i.e., they share one or more common strings) and yet also do not have a common shared regular expression (i.e., they do not share a regular expression that matches all of the strings matched by the N regular expressions).

### BRIEF SUMMARY

A method, apparatus and computer program product are therefore provided according to an example embodiment of the present invention for testing software programs using two or more regular expressions that need to be disjoint. The method, apparatus, and computer program of another embodiment may determine one or more common regular expressions shared by two or more regular expressions. Thus, by utilizing the method, apparatus, and computer program of these embodiments, a software engineer may more effectively debug a software programs which use regular expressions.

In one embodiment, a method is provided that includes receiving two or more regular expressions and determining whether a common regular expression exists between the two or more regular expressions. The method further includes, in an instance in which it is determined that a common regular expression does not exist between the two or more regular expressions, causing an indication that the two or more regular expressions are disjoint to be provided; and in an instance in which it is determined that a common regular expression does exist between the two or more regular expressions, causing an indication that the two or more regular expressions are not disjoint to be provided.

In another embodiment, a method is provided that includes determining the value of a common regular expression for two or more regular expressions by causing respective deterministic finite automaton (DFA) representations for each of the two or more regular expressions, causing a DFA representation of a candidate common regular expression to be created based on the DFA representations of the two or more regular expressions, determining whether the DFA representation of the candidate common regular expression includes a terminal state, and, in an instance in which the DFA representation of the candidate common regular expression does not include a terminal state, causing the value of the common regular expression to be defined as null. The method may further include, in an instance in which the DFA representation of the candidate common regular expression does include a terminal state, causing the candidate common regular expression to be assembled based on the DFA representation of the candidate common regular expression, and causing the value of the common regular expression to be defined as the candidate common regular expression.

In a further embodiment, an apparatus is provided that includes at least one processor and at least one memory including program code instructions, the at least one memory and the program code instructions being configured to, with the processor, direct the apparatus to at least receive two or more regular expressions and determine whether a common regular expression exists between the two or more regular expressions. The apparatus is further directed to, in an instance in which it is determined that a common regular expression does not exist between the two or more regular expressions, cause an indication that the two or more regular expressions are disjoint to be provided and, in an instance in which it is determined that a common regular expression does exist between the two or more regular expressions, cause an indication that the two or more regular expressions are not disjoint to be provided.

In another embodiment, an apparatus is provided that includes at least one processor and at least one memory including program code instructions, the at least one memory and the program code instructions being configured to, with the processor, direct the apparatus to at least determine the value of a common regular expression for two or more regular expressions by causing respective deterministic finite automaton (DFA) representations for each of the two or more regular expressions, causing a DFA representation of a candidate common regular expression to be created based on the DFA representations of the two or more regular expressions, determining whether the DFA representation of the candidate common regular expression includes a terminal state, and, in an instance in which the DFA representation of the candidate common regular expression does not include a terminal state, causing the value of the common regular expression to be defined as null. The apparatus may be further directed to, in an instance in which the DFA representation of the candidate common regular expression does include a terminal state, cause the candidate common regular expression to be assembled based on the DFA representation of the candidate common regular expression, and cause the value of the common regular expression to be defined as the candidate common regular expression.

In an even further embodiment, a computer program product is provided that includes a non-transitory computer readable medium storing program code portions therein. The computer program code instructions are configured to, upon execution, cause an apparatus to at least receive two or more regular expressions and determine whether a common regular expression exists between the two or more regular expressions. The apparatus is further caused to, in an instance in which it is determined that a common regular expression does not exist between the two or more regular expressions, cause an indication that the two or more regular expressions are disjoint to be provided and, in an instance in which it is determined that a common regular expression does exist between the two or more regular expressions, cause an indication that the two or more regular expressions are not disjoint to be provided.

In another embodiment, a computer program product is provided that includes a non-transitory computer readable medium storing program code portions therein. The computer program code instructions are configured to, upon execution, cause an apparatus to at least determine the value of a common regular expression for two or more regular expressions by causing respective deterministic finite automaton (DFA) representations for each of the two or more regular expressions, causing a DFA representation of a candidate common regular expression to be created based on the DFA representations of the two or more regular expressions, determining whether the DFA representation of the candidate common regular expression includes a terminal state, and, in an instance in which the DFA representation of the candidate common regular expression does not include a terminal state, causing the value of the common regular expression to be defined as null. The apparatus may be further caused to, in an instance in which the DFA representation of the candidate common regular expression does include a terminal state, cause the candidate common regular expression to be assembled based on the DFA representation of the candidate common regular expression, and cause the value of the common regular expression to be defined as the candidate common regular expression.

In a still further embodiment, an apparatus is provided that includes means for receiving two or more regular expressions and determining whether a common regular expression exists between the two or more regular expressions. The apparatus further includes means for, in an instance in which it is determined that a common regular expression does not exist between the two or more regular expressions, causing an indication that the two or more regular expressions are disjoint to be provided; and means for, in an instance in which it is determined that a common regular expression does exist between the two or more regular expressions, causing an indication that the two or more regular expressions are not disjoint to be provided.

In another embodiment, an apparatus is provided for determining the value of a common regular expression for two or more regular expressions. The apparatus includes means for causing respective deterministic finite automaton (DFA) representations for each of the two or more regular expressions, means for causing a DFA representation of a candidate common regular expression to be created based on the DFA representations of the two or more regular expressions, means for determining whether the DFA representation of the candidate common regular expression includes a terminal state, and means for, in an instance in which the DFA representation of the candidate common regular expression does not include a terminal state, causing the value of the common regular expression to be defined as null. The apparatus may further include means for, in an instance in which the DFA representation of the candidate common regular expression does include a terminal state, causing the candidate common regular expression to be assembled based on the DFA representation of the candidate common regular expression, and means for causing the value of the common regular expression to be defined as the candidate common regular expression.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a block diagram of an apparatus that may be embodied by or associated with an electronic device, and may be configured to implement example embodiments of the present invention;

FIGS. 2 and 3 are flowcharts illustrating operations according to embodiments of the present invention; and

FIG. 4 is a flowchart illustrating the use of a testing program according to an embodiment of the present invention being used to test a program that uses regular expressions that should be disjoint.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Also as used herein, the terms “modify” and “update” may be used interchangeably to refer to modifying or changing a file in accordance with embodiments of the present invention, and may refer to the file being “updated” to match a more current version, modified to match an older version, or modified in any other way or for any other purpose. Moreover, a “file” as used herein may refer to any collection of related data or program records stored as a unit. Thus, a “file” as used herein may, for example, represent any discrete component of a software program, firmware, or any other set of machine or computer readable instructions or data. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As described below, a method, apparatus and computer program product are provided for testing software programs employing two or more regular expressions. In this regard, the method, apparatus and computer program product of an example embodiment may test a software program employing two or more regular expressions to determine whether the regular expressions disjoint. The method, apparatus, and computer program of another embodiment may determine one or more common regular expressions for the two or more regular expressions. Thus, the method, apparatus, and computer program of these embodiments may allow software programs which use two or more regular expressions to be tested to determine whether the two or more regular expressions are disjoint and also tested to determine a common regular expression of the two or more regular expressions, such as for the purpose of debugging the disjointedness of the regular expressions.

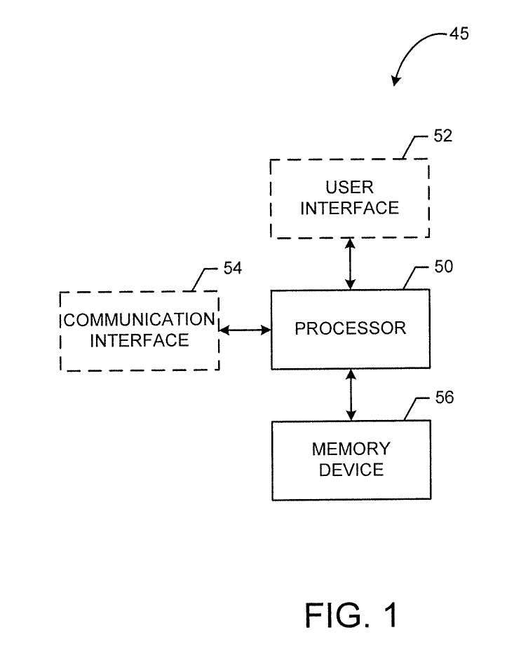

Example embodiments of the invention will now be described with reference to FIG. 1, in which certain elements of an apparatus 45 for testing a software program are depicted. In order to test a software program, the apparatus 45 of FIG. 1 may be employed, for example, in conjunction with a computing device or system, such as a personal computer, laptop computer, mainframe computer, distributed or cloud computer system or the like. However, it should be noted that the apparatus 45 of FIG. 1 may also be employed in connection with a variety of other devices, both mobile and fixed, in order to test software programs, such as any type of user terminal.

It should also be noted that while FIG. 1 illustrates one example of a configuration of an apparatus 45 for to testing software programs, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 1, the apparatus 45 for preparing and/or installing update packages for compressed files may include or otherwise be in communication with a processor 50 and a memory device 56. As described below and as indicated by the dashed lines in FIG. 1, the apparatus 45 may also optionally include a user interface 52 and/or a communication interface 54 in some embodiments. In some embodiments, the processor 50 (and/or co-processors or any other processing circuitry assisting or otherwise associated with the processor 50) may be in communication with the memory device 56 via a bus for passing information among components of the apparatus 45. The memory device 56 may include, for example, one or more volatile and/or non-volatile memories. In other words, for example, the memory device 56 may be an electronic storage device (e.g., a computer readable storage medium) comprising gates configured to store data (e.g., bits) that may be retrievable by a machine (e.g., a computing device like the processor 50). The memory device 56 may be configured to store information, data, content, applications, instructions, or the like, for enabling the apparatus to carry out various functions in accordance with an example embodiment of the present invention. For example, the memory device 56 could be configured to buffer input data for processing by the processor 50. Additionally or alternatively, the memory device 56 could be configured to store instructions for execution by the processor 50.

The apparatus 45 may, in some embodiments, be embodied by or associated with a user terminal or a fixed computing device configured to employ an example embodiment of the present invention. However, in some embodiments, the apparatus 45 may be embodied as a chip or chip set. In other words, the apparatus 45 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 45 may therefore, in some cases, be configured to implement an embodiment of the present invention on a single chip or as a single “system on a chip.” As such, in some cases, a chip or chipset may constitute means for performing one or more operations for providing the functionalities described herein.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include one or more processors configured in tandem via the bus to enable independent execution of instructions, pipelining and/or multithreading. In the embodiment in which the apparatus 45 is embodied as a mobile terminal 25, the processor 50 may be embodied by the processor 22.

In an example embodiment, the processor 50 may be configured to execute instructions stored in the memory device 56 or otherwise accessible to the processor 50. Alternatively or additionally, the processor 50 may be configured to execute hard coded functionality. As such, whether configured by hardware or software methods, or by a combination thereof, the processor 50 may represent an entity (e.g., physically embodied in circuitry) capable of performing operations according to an embodiment of the present invention while configured accordingly. Thus, for example, when the processor 50 is embodied as an ASIC, FPGA or the like, the processor 50 may be specifically configured hardware for conducting the operations described herein. Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (e.g., a mobile terminal or network entity) configured to employ an embodiment of the present invention by further configuration of the processor 50 by instructions for performing the algorithms and/or operations described herein. The processor 50 may include, among other things, a clock, an arithmetic logic unit (ALU) and logic gates configured to support operation of the processor 50.

Meanwhile, the communication interface 54 may be any means such as a device or circuitry embodied in either hardware or a combination of hardware and software that is configured to receive and/or transmit data from/to a network and/or any other device or module in communication with the apparatus 45. In this regard, the communication interface 54 may support wired communication. As such, for example, the communication interface 54 may include a communication modem and/or other hardware/software for supporting communication via cable, digital subscriber line (DSL), universal serial bus (USB) or other mechanisms. In some environments, the communication interface 54 may alternatively or also support wireless communication. Accordingly, the communication interface 54 may include, for example, an antenna (or multiple antennas) and supporting hardware and/or software for enabling communications with a wireless communication network. Thus, the communication interface 54 may include the circuitry for interacting with the antenna(s) to cause transmission of signals via the antenna(s) or to handle receipt of signals received via the antenna(s).

In some embodiments apparatus 45 may include a user interface 52 that may, in turn, be in communication with the processor 50 to receive an indication of a user input and/or to cause provision of an audible, visual, mechanical or other output to the user. As such, the user interface 52 may include, for example, a keyboard, a mouse, a joystick, a display, a touch screen(s), touch areas, soft keys, a microphone, a speaker, or other input/output mechanisms. Alternatively or additionally, the processor 50 may comprise user interface circuitry configured to control at least some functions of one or more user interface elements such as, for example, a speaker, display, and/or the like. The processor 50 and/or user interface circuitry comprising the processor 50 may be configured to control one or more functions of one or more user interface elements through computer program instructions (e.g., software and/or firmware) stored on a memory accessible to the processor 50 (e.g., memory device 56, and/or the like).

Before proceeding with the description of various embodiments of the present invention, it is beneficial to briefly consider some of the basic concepts underpinning those embodiments, as well as to provide definitions for some terms that will be used in their descriptions.

In this regard, a regular expression, or “regex” for short, is a pattern that describes, (e.g., specifies, matches, recognizes, etc.) strings of text. For example, the regex “.*car.*” would match any of the following strings: “car”, “motorcar”, “bicarbonate”, or “cartoon”. Additional complexity can be added to a regex through the use of special characters, such as brackets to represent a class or range of characters, e.g., [0-9] would match a single digit between 0 and 9 while gr[ae]y would match either “gray” or “grey”. Many other operations can be used in regular expressions. For example, given regular expressions A and B: AB represents the concatenation of A and B, AIB represents alternation between A and B, and A* represents the Kleene star of A. The priority of these operations is (from highest to lowest): Kleene star, concatenation and alternation, but parentheses can be used to change the priority. The symbols “*”, “|”, “(“, and”)” can also be used as literals in the regular expression by escaping them with a backslash symbol “\”. For example, using “\|” in a regex would represent a literal “|”.

A person of ordinary skill will appreciate that regexes may provide a tremendous amount of functionality and complexity beyond that demonstrated in these simple examples. Accordingly, the full spectrum of regex utility will not be discussed further.

All possible strings that a regular expression matches may be referred to as a “regular language.” This regular language can be generated by a Type-3 grammar in the Chomsky hierarchy and thus can also be accepted by a (Non)Deterministic Finite Automaton (see Noam Chomsky, “Three models for the description of language”, IRE Transactions on Information Theory (2), 1956). Thus, it follows that a regular expression may be transformed into, e.g., represented as, a Nondeterministic Finite Automaton (NFA).

A regular expression can be transformed into a Nondeterministic Finite Automaton using Thomson's Algorithm with worst case time and space complexity O(n), where n is the length of the regular expression (see Ken Thompson, “Regular expression search algorithm”, Communications of the ACM 11 (6), June 1968). Furthermore a Nondeterministic Finite Automaton can be transformed into a Deterministic Finite Automaton (DFA) using the Powerset Construction algorithm with worst case time and space complexity of O(2ⁿ), where n is the number of states of the Nondeterministic Finite Automaton (see Michael O. Rabin and Dana Scott, “Finite automata and their decision problems”, IBM Journal of Research and Development 3 (2), 1959).

Having now briefly discussed some underlying concepts, various embodiments of the present invention will now be described. In this regard, as mentioned above, one embodiments of the present invention may be used to determine whether two or more regular expressions are disjoint. Another embodiment may be used to extract a common regular expression of two or more regular expression. Thus, embodiments of the present invention may, for example, be included in a testing environment, such as testing software, in order to test software programs which utilize two or more regular expressions. In this regard, embodiments of the present invention may determine whether or not the two or more regular expressions are disjoint, which may, for example, be useful when the two or more regular expressions are required by the tested software to be disjoint (or not disjoint). In another regard, an embodiment according to the present invention which extracts a common regular expression of two or more regular expressions may, for example, be useful for debugging disjointedness—that is, if the common regular expression of two or more non-disjoint regular expressions is known, this may make it easier to alter one or more of the regular expressions so that they are disjoint.

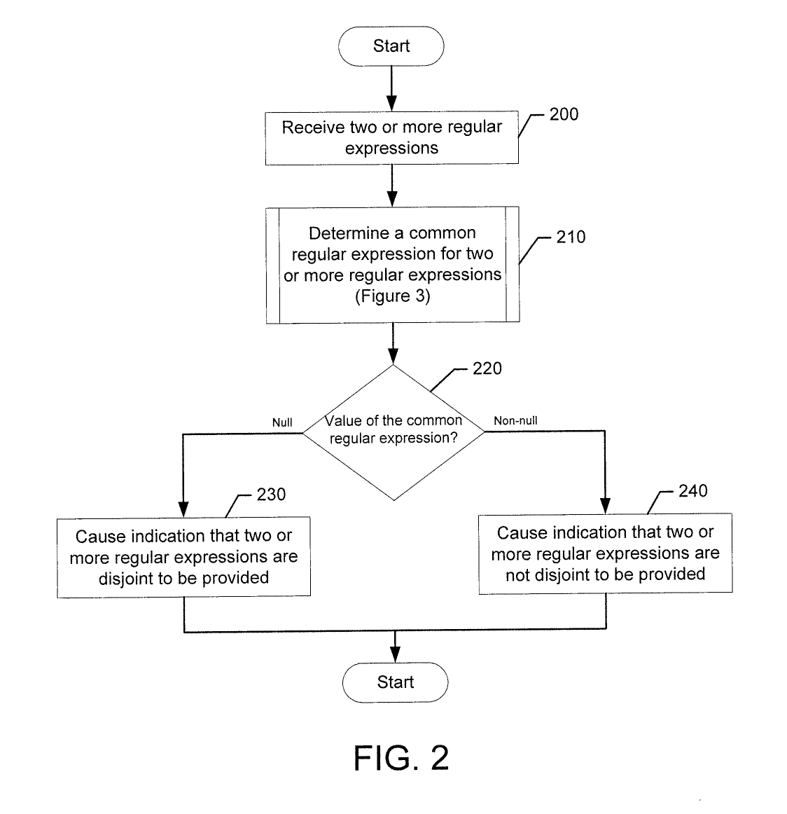

Thus, turning now to FIG. 2, the operations of apparatus 45 for testing disjointedness are depicted. In this regard the apparatus 45 may include means, such as processor 50 and memory device 56 or the like, for receiving two or more regexes. See operation 200. The two or more regular expressions may, for example, be extracted from a software program that is being tested. According to another example embodiment, the two or more regular expressions may be input by a user, such as by manually entering them or through selection. According to example embodiments in which the operations depicted in FIG. 2 are implemented via software, e.g., with program code instructions embodied in memory, such as memory device 56, and executed by a process, such as processor 50, receiving the two or more regexes may comprise receiving the regexes as arguments or inputs of a function.

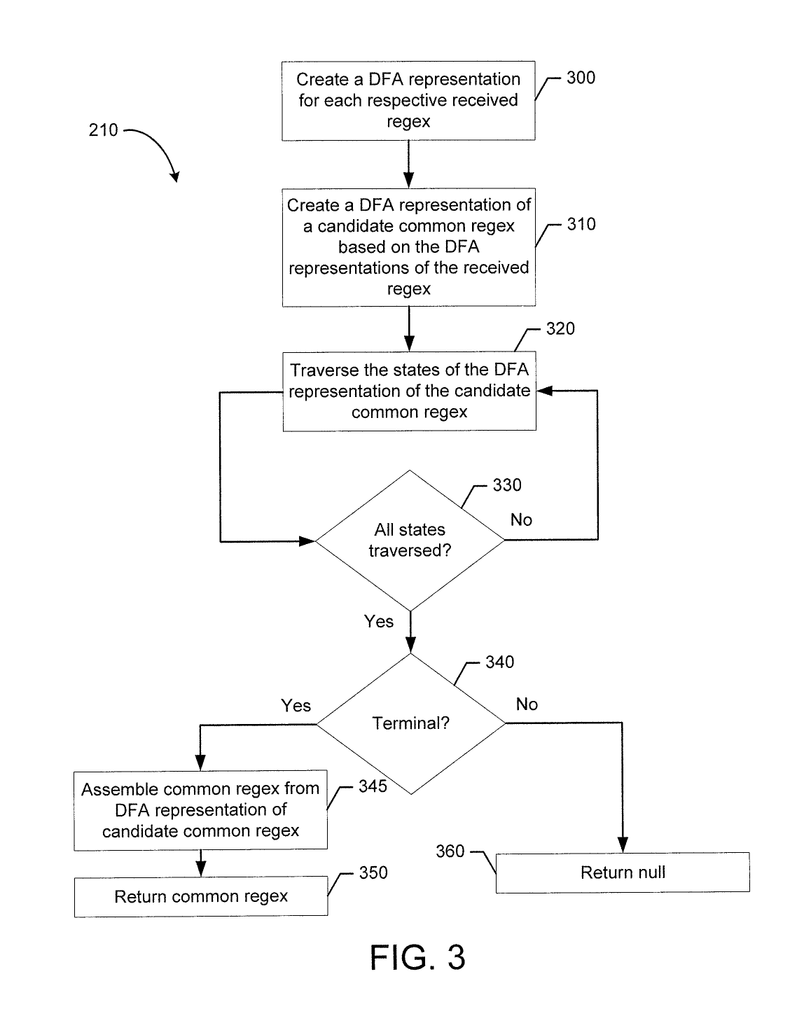

Apparatus 45 may further include means, such as processor 50 and memory device 56 or the like, for determining a common regular expression. See operation 210. This operation is depicted in FIG. 3a and discussed in detail below. It should be understood that while there will be only one common regular expression. However, it should also be understood that there may be many equivalent ways of expressing any given regular expression, such that there may be many equivalent common regular expressions, each of which are essentially the same, i.e., they return the same strings, but are expressed in different ways. For example, if the common regular expression were found to be “a|b”, this could also be expressed as “b|a” (which is equivalent to “a|b”), such that “b|a” could also be said to be the common regular expression. For the purposes of discussion, all equivalent common regular expressions should be considered as the same regular expression, such that references to “a common regular expression” or “the common regular expression” should not be understood as being strictly limited to a “single” regular expression, i.e., it should not be interpreted as precluding the possibility that there will be any number of regular expressions equivalent to “the” common regular expression.

Continuing to refer to FIG. 2, Apparatus 45 may further include means, such as processor 50 and memory device 56 or the like, for determining whether the value of the one or more common regular expressions is null or not. See operation 220. Apparatus 45 may also include such as those mentioned above, for causing an indication that the two or more regular expressions are disjoint to be provided in an instance in which the value of the one or more common regular expressions is null. See operation 230. Apparatus 45 may also include means, such as those mentioned above, and for causing an indication that the two or more regular expressions are not disjoint to be provided in an instance in which the value of the one or more common regular expressions is not null. See operation 240. These indications may, for example, be returned as the output of an associated programming function.

Thus, according to an example embodiment, the above may be implemented as a program function via program code instructions embodied in at least one memory, such as memory device 56 of apparatus 45, and executable by at least one processor, such as processor 50 of apparatus 45. An example of pseudocode program code instructions for implementing such a function is provided below:

```
function testDisjoint(regexes, N)
  for i := 1 to N − 1
    for j := i + 1 to N
      regexPair := {regexes[i], regexes[j]}
      commonRegex := getCommonRegex(regexPair, 2)
      if commonRegex ≠ null
        return false
  return true
```

In this regard, the above depicted “testDisjoint” function receives N regular expressions (along with ‘N’ itself), returns true if there is no common regular expression, i.e., if the common regular expression value is null, and returns false if there is a common regular expression, i.e., if the common regular expression value is not null. Thus, “true” indicates that the received two or more regular expressions are disjoint, and “false” indicates that they are not disjoint. As depicted in FIGS. 2, the test for disjointedness relies on determining a common regular expression, e.g., through the “getCommonRegex” function, the details of which will now be discussed.

According to an embodiment of the present invention, regex C is a common regex of regexes A and B if: (1) every string that is matched by C is also matched by A and B and (2) C does not match strings that do not match A and B. These properties may be tested according to an example embodiment, through the use of DFAs, as will now be discussed.

Thus, turning now to FIG. 3, the operations of apparatus 45 for determining a common regular expression of two or more regular expressions are depicted. In this regard the apparatus 45 may include means, such as processor 50 and memory device 56 or the like, for creating a DFA for each respective received regex. See operation 300 of FIG. 3. According to an example embodiment, creating a DFA representation for each of the received regexes may involve first creating a NFA representation for each of the regexes and then transforming the NFA representations into respective DFA representations as previously discussed. Apparatus 45 may further include means, such as those mentioned above, for creating a DFA representation of a candidate common regex based on the DFA representations of the received regexes (the “regex DFAs”). See operation 310 of FIG. 3. In this regard, the start state of the DFA representation of the candidate common regex (the “candidate DFA”) may be created from the start states of the regex DFAs. Thus, according to an example embodiment, the start state of the candidate DFA is the set of all start states of the regex DFAs. The additional states of the candidate DFA may be constructed as follows, according to an example embodiment. First, the states of each of the regex DFAs may be traversed, such as through the use of a FIFO (first in first out) queue structure, to determine respective symbol sets for each of the regex DFAs. Next the symbol sets determined for each of the regex DFAs may be intersected, so as to determine a common symbol set. State transitions may then be created based on each symbol in the common symbol set. Apparatus 45 may further include means, such as those mentioned above, for traversing each states of the candidate DFA and determining whether the candidate DFA has a terminal state. See operations 320, 330, and 340 of FIG. 3. According to an alternate embodiment, operations 310, 320, 330, and 340 may occur in parallel, such that the candidate DFA is continually tested for terminality as it is constructed. Apparatus 45 may further include means, such as those mentioned above for returning, in an instance in which all of the states of the candidate DFA are traversed, but no terminal state is found, a null value. See operation 360 of FIG. 3. As discussed above, the test for disjointedness, such as is implemented in a testDisjointedness function as described above, may interpret a null common regex value as an indication that the regexes are disjoint. Apparatus 45 may further include means, such as those mentioned above, for assembling, in an instance in which all of the states of the candidate DFA are traversed and a terminal state has been found, a common regex from the DFA representation of the candidate common regex. See operation 345 of FIG. 3. Apparatus 45 may include further means, such as those mentioned above, for returning the common regex assembled in operation 345. See operation 350.

Thus, according to an example embodiment, the above may, for example, be implemented as a program function via program code instructions embodied in at least one memory, such as memory device 56 of apparatus 45, and executable by at least one processor, such as processor 50 of apparatus 45. An example of pseudocode program code instructions for implementing such a function is provided below (with comments denoted by “//”):

```
function getCommonRegex(regexes, N)
  // Create a DFA representation for every regex. This is done by
  // creating NFA representations and then transforming the NFAs into
  // DFAs. The states from the DFAs will thus be sets of states from the
  // NFAs.
  for i := 1 to N
    dfa[i] := createDfa(regexes[i])
  // A terminal state is a state (in an NFA or DFA) where the traversing
  // of the NFA or DFA can end.
  // “hasTerminal” will be true if there is any terminal state in
  // the common regex or false otherwise. In case this is false at the
  // end of the algorithm then it means that there is no common regex.
  hasTerminal := false
  // When constructing the states of the common regex we don't want to
  // have infinite loops, to prevent this we keep a record of which
  // which states we created and mark those as visited.
  visited := { }
  // The start state of the DFA of the common regex will be the set of
  // all the start states of the DFAs of all the regexes.
  for i := 1 to N
  commonStartState[i] := dfa[i].startState
  // Use a FIFO queue data structure to traverse the DFAs of all
  // the regexes and construct the DFA of the common regex.
  // Note that the states of the DFA of the common regex are sets of
  // states of the DFAs of the regexes.
  queue := { commonStartState }
  while size(queue) > 0
    commonState := queue.dequeue( )
    visited := visited ∪ commonState
    // Get the sets of next symbols from every current DFA state
    // (commonState) of every regex.
    for i := 1 to N
      symbols[i] := getNextSymbols(commonState[i])
      if commonState[i].isTerminal
        hasTerminal := true
    // Intersect all the sets and get the set of common symbols
    // (because we want the common regex).
    commonSymbols := symbols[1] ∩ symbols[2] ∩ . . . ∩ symbols[N]
    // For each symbol from the set create a transition from the
    // current state to the destination state by consuming the symbol,
    // and if the destination state is not visited yet then plan to
    // visit it by adding it to the queue.
  for each symbol in commonSymbols
    for i := 1 to N
      nextCommonState[i] := getNextState(commonState[i], symbol)
    if nextCommonState ∉ visited
      visited := visited ∪ nextCommonState
      queue.enqueue(nextCommonState)
    addNextState(commonState, symbol, nextCommonState)
// In case there are no terminal states in the DFA of the common regex
// then there is no common regex for the regular expressions.
// Otherwise return the common regex already implemented/constructed
// as a DFA.
commonRegex := null
if hasTerminal
  commonDfa := getDfa(commonStartState)
  commonRegex := assembleRegex(commonDfa)
return commonRegex
```

The “getCommonRegex” function depicted above thus receives N regular expressions (along with ‘N’ itself) and returns the common regular expression (or null if there is no common regular expression). The getCommonRegex function depicted above relies on the following utility functions:

createDfa(regex)—creates a Deterministic Finite Automaton from the provided regex argument; the returned DFA is an object with a start state, and a transition function between states, which is abstracted in the getNextState function;

getNextState(state, symbol)—uses the transition function associated with the DFA of the given state argument and returns the next reachable state from the given state and symbol arguments;

getNextSymbols(state)—determines and returns all the next possible symbols usable to reach some state from the given state argument;

addNextState(state, symbol, nextState)—updates the transition function of the DFA associated with the given state argument by inserting a symbol path to the nextState state, thus making it reachable;

getDfa(startState)—returns the DFA associated with the startState; and

assembleRegex(dfa)—transforms the given dfa into a regular expression like object, this can be easily accomplished since the regular expressions have the same methods as the DFA (actually regular expressions use DFA as their implementation).

It should be understood that the time and space complexity in the worst case for the getCommonRegex function depicted in FIG. 3b, or any embodiment of the present invention utilizing the operations depicted in FIG. 3a, is O(n₁*n₂* . . . *nₖ), where nᵢ is the number of states of the DFA from the regex i.

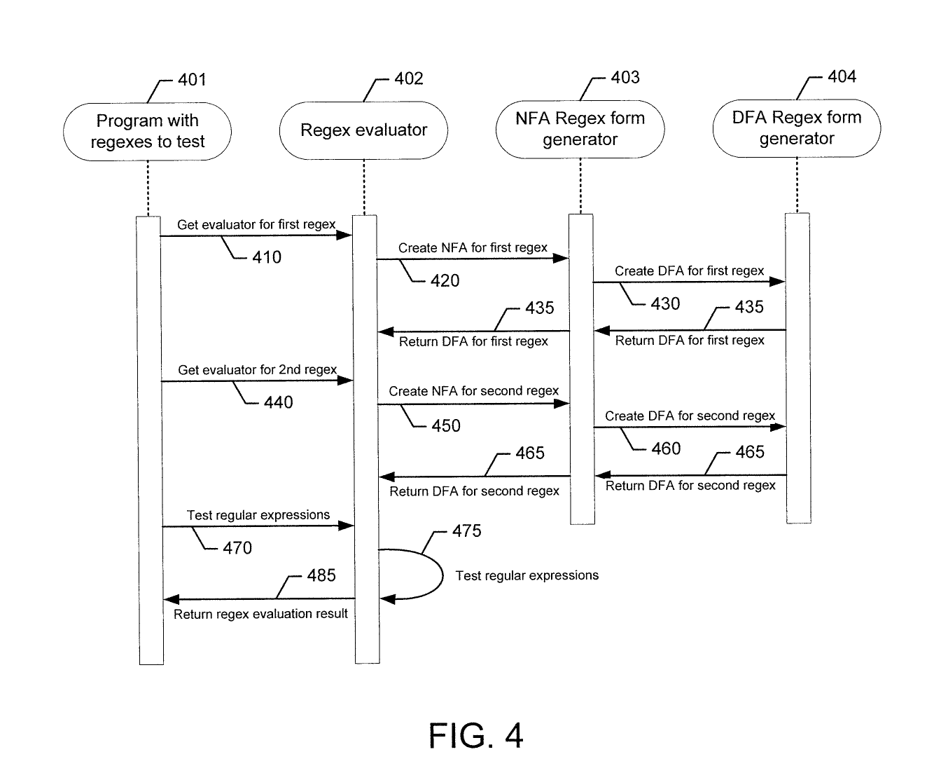

As mentioned above, embodiments of the present invention may be implemented, for example, in a software testing environment. Turning now to FIG. 4, the operations of embodiments of the present invention, when deployed in a software testing environment, will now be discussed. In this regard, regex evaluator 402 may receive a first regex from a program with regexes to test 401, so that an evaluator for the first regex may be obtained. See operation 410. Regex evaluator 402 may then pass the received first regex to NFA regex form generator 403 so that NFA regex form generator 403 may create an NFA for the first regex. See operation 420. The NFA regex form generator may then provide the created NFA for the first regex to DFA regex form generator 404. See operation 430. The DFA regex generator 404 may then return the DFA for the first regex to the regex evaluator 402. See operation 435. The process may then repeated for the second regex and for any additional regexes beyond two. See operations 440, 450, 460, and 465. Having received a DFA for all of the regexes to be tested, regex evaluator 402 may receive an indication to test the regular expressions. See operation 470. In response, regex evaluator 402 may then test the regular expressions, such as by testing them according to any of the various embodiments discussed above, and then return the results of the test. See operations 475 and 485.

As described above, FIGS. 2a, 3a, and 4 illustrate flowcharts of an apparatus 45, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. Moreover, one or more of the entities described above, such as the regex evaluator 402, NFA regex form generator 403, and DFA regex form generator 404 and the like may also be embodied by computer program instructions. In this regard, the computer program instructions which embody the procedures described above may be stored by a memory device 56 of an apparatus 45 employing an embodiment of the present invention and executed by a processor 50 of the apparatus 45. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

The methods, apparatuses 45 and computer program products described above provide many advantages. For example the method, apparatus 45 and computer program products may improve the testing of programs that use regular expression by providing a general method for verifying and validating the correctness of the program. A further advantage of the methods, apparatuses 45 and computer program products described above is that they allow for general testing, meaning they do not require particular use cases for the input of the regular expressions. Thus the methods, apparatuses 45 and computer program products described above may provide a more reliable way of testing regular expressions that need to be disjoint.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving two or more regular expressions;
determining whether a common regular expression exists between the two or more regular expressions;
in an instance in which it is determined that a common regular expression does not exist between the two or more regular expressions, causing an indication that the two or more regular expressions are disjoint to be provided; and
in an instance in which it is determined that a common regular expression does exist between the two or more regular expressions, causing an indication that the two or more regular expressions are not disjoint to be provided.

2. The method of claim 1, wherein determining whether a common regular expression exists between the two or more regular expressions comprises determining whether every string that is accepted by the common regular expression is also accepted by all of the two or more regular expressions.

3. The method of claim 1, wherein determining whether a common regular expression exists between the first and second regular expression comprises determining a value of the common regular expression;
wherein:
in an instance in which the value of the common regular expression is null, it is determined that the common regular expression does not exist between the two or more regular expressions; and
in an instance in which the value of the common regular expression is not null, it is determined that the common regular expression does exist between the two or more regular expressions.

4. The method of claim 3, wherein determining the value of the common regular expression comprises:
causing respective deterministic finite automaton (DFA) representations of the two or more regular expressions to be created;
causing a DFA representation of a candidate common regular expression to be created based on the DFA representations of the two or more regular expressions;
determining whether the DFA representation of the candidate common regular expression includes a terminal state; and
in an instance in which the DFA representation of the candidate common regular expression does not include a terminal state, causing the value of the common regular expression to be defined as null.

5. The method of claim 4, further comprising, in an instance in which the DFA representation of the candidate common regular expression does include a terminal state:
causing the candidate common regular expression to be assembled based on the DFA representation of the candidate common regular expression, and
causing the value of the common regular expression to be defined as the candidate common regular expression.

6. The method of claim 4, wherein the DFA representations of the two or more regular expressions comprise respective start states and causing the DFA representation of the candidate common regular expression to be created comprises causing a set of start states for the DFA representation of the candidate common regular expression to be created, the set of start states comprising the start states of the DFA representations of the two or more regular expressions.

7. The method of claim 4, wherein causing the DFA representation of the candidate common regular expression to be created comprises:
determining respective symbol sets of each of the DFA representations of the two or more regular expressions by traversing each of the DFA representations of the two or more regular expressions;
determining a common symbol set by intersecting the symbol sets; and
determining state transitions based on each symbol in the common symbol set.

8. A computer program product comprising a non-transitory computer readable storage medium storing program code instructions therein, the program code instructions being configured to, upon execution, cause an apparatus to at least:
receive two or more regular expressions;
determine whether a common regular expression exists between the two or more regular expressions;
in an instance in which it is determined that a common regular expression does not exist between the two or more regular expressions, cause an indication that the two or more regular expressions are disjoint to be provided; and
in an instance in which it is determined that a common regular expression does exist between the two or more regular expressions, cause an indication that the two or more regular expressions are not disjoint to be provided.

9. The computer program product of claim 8, wherein the apparatus is caused to determine whether a common regular expression exists between the two or more regular expressions by determining whether every string that is accepted by the common regular expression is also accepted by all of the two or more regular expressions.

10. The computer program product of claim 8, wherein the apparatus is caused to determine whether a common regular expression exists between the first and second regular expression by determining a value of the common regular expression;
wherein:
in an instance in which the value of the common regular expression is null, it is determined that a common regular expression does not exist between the two or more regular expressions; and
in an instance in which the value of the common regular expression is not null, it is determined that a common regular expression does exist between the two or more regular expressions.

11. The computer program product of claim 10, wherein the apparatus is caused to determine the value of the common regular expression by:
causing respective deterministic finite automaton (DFA) representations of the two or more regular expressions to be created;
causing a DFA representation of a candidate common regular expression to be created based on the DFA representations of the two or more regular expressions;
determining whether the DFA representation of the candidate common regular expression includes a terminal state; and
in an instance in which the DFA representation of the candidate common regular expression does not include a terminal state, causing the value of the common regular expression to be defined as null.

12. The computer program product of claim 11, wherein the apparatus is further caused to, in an instance in which the DFA representation of the candidate common regular expression does include a terminal state:
cause the candidate common regular expression to be assembled based on the DFA representation of the candidate common regular expression, and
cause the value of the common regular expression to be defined as the candidate common regular expression.

13. The computer program product of claim 11, wherein the DFA representations of the two or more regular expressions comprise respective start states and the apparatus is caused to cause the DFA representation of the candidate common regular expression to be created by causing a set of start states for the DFA representation of the candidate common regular expression to be created, the set of start states comprising the start states of the DFA representations of the two or more regular expressions.

14. The computer program product of claim 11, wherein the apparatus is caused to cause the DFA representation of the candidate common regular expression to be created by:
determining respective symbol sets of each of the DFA representations of the two or more regular expressions by traversing each of the DFA representations of the two or more regular expressions;
determining a common symbol set by intersecting the symbol sets; and
determining state transitions based on each symbol in the common symbol set.

15. An apparatus comprising at least one processor and at least one memory storing program code instructions, the memory and program code instructions being configured to, upon execution, cause the apparatus to at least:
receive two or more regular expressions;
determine whether a common regular expression exists between the two or more regular expressions;
in an instance in which it is determined that a common regular expression does not exist between the two or more regular expressions, cause an indication that the two or more regular expressions are disjoint to be provided; and
in an instance in which it is determined that a common regular expression does exist between the two or more regular expressions, cause an indication that the two or more regular expressions are not disjoint to be provided.

16. The apparatus of claim 15, wherein the apparatus is caused to determine whether a common regular expression exists between the first and second regular expression by determining a value of the common regular expression;
wherein:
in an instance in which the value of the common regular expression is null, it is determined that a common regular expression does not exist between the two or more regular expressions; and
in an instance in which the value of the common regular expression is not null, it is determined that a common regular expression does exist between the two or more regular expressions.

17. The apparatus of claim 16, wherein the apparatus is caused to determine the value of the common regular expression by:
causing respective deterministic finite automaton (DFA) representations of the two or more regular expressions to be created;
causing a DFA representation of a candidate common regular expression to be created based on the DFA representations of the two or more regular expressions;
determining whether the DFA representation of the candidate common regular expression includes a terminal state; and
in an instance in which the DFA representation of the candidate common regular expression does not include a terminal state, causing the value of the common regular expression to be defined as null.

18. The apparatus of claim 17, wherein the apparatus is further caused to, in an instance in which the DFA representation of the candidate common regular expression does include a terminal state:
cause the candidate common regular expression to be assembled based on the DFA representation of the candidate common regular expression, and
cause the value of the common regular expression to be defined as the candidate common regular expression.

19. The apparatus of claim 17, wherein the DFA representations of the two or more regular expressions comprise respective start states and the apparatus is caused to cause the DFA representation of the candidate common regular expression to be created by causing a set of start states for the DFA representation of the candidate common regular expression to be created, the set of start states comprising the start states of the DFA representations of the two or more regular expressions.

20. The apparatus of claim 17, wherein the apparatus is caused to cause the DFA representation of the candidate common regular expression to be created by:
determining respective symbol sets of each of the DFA representations of the two or more regular expressions by traversing each of the DFA representations of the two or more regular expressions;
determining a common symbol set by intersecting the symbol sets; and
determining state transitions based on each symbol in the common symbol set.
